(19) United States
(12) Patent Application Publication
(10) Pub. No.: US 2021/0388922 A1
(43) Pub. Date: Dec. 16, 2021

(54) HYDRAULIC MICROVALVE

(71) Applicant: MST INNOVATION GMBH, Dortmund (DE)

(72) Inventors: Frank Bartels, Hattingen (DE); Carmen Streich, Essen (DE)

(21) Appl. No.: 17/282,769

(22) PCT Filed: Oct. 4, 2019
(86) PCT No.: PCT/IB2019/058484

§ 371 Date: Apr. 4, 2021

(30) Foreign Application Priority Data
Oct. 4, 2018 (DE) 10 2018 124 467.3

(51) Int. Cl. F16K 99/00; F04B 43/04

(52) U.S. Cl. CPC F16K 99/0015; F04B 43/046; F16K 99/0055

(57) ABSTRACT

A miniaturized hydraulic valve having a valve chamber arranged in a housing having an inlet and an outlet, wherein a wall includes a shifting member movable in the direction of the inlet and/or the outlet, and wherein a fluid-filled drive chamber is arranged on an opposite side of the wall, which is connected to a micropump in such a way that the shifting member can be actively deflected by fluid which can be pressurized by means of the micropump, so that its position can be changed relative to the inlet and/or outlet.

### TECHNICAL FIELD

The invention relates to a valve. In particular, the invention relates to a hydraulic valve.

### BACKGROUND OF THE INVENTION

Valves are well known from the state of the art. They are used for switching fluids (liquids, gases), i.e. they allow the targeted passage or blocking of fluid flows in pipelines and the like.

A distinction is made between passive and active valves. Passive valves are switched by the fluid flow itself, e.g. a flap valve whose flaps are pressed open by a fluid flow in the direction of flow and are pressed against the valve seat and thus closed by an opposite fluid flow. Active valves, on the other hand, allow switching independently of the fluid flow.

Active valves can also be operated in a variety of ways. For example, purely mechanical valves are known that are operated by way of forces, or electromechanical valves that must be supplied with electricity for operation. What active valves have in common is the necessity of the presence of a switching energy, which results in the movement of an shifting member in the valve. Depending on the position of the shifting member, the fluid can then flow or is blocked.

Frequently, the shifting member takes a rest position without energy supply, which either allows a fluid flow (“normally open”) or blocks it (“normally closed”). Thus, a supply of switching energy results in the transition to an activated state that opens or closes the valve, depending on the design. An interruption of the energy supply results again in entering the resting state.

An example of small-sized active valves are valves based on piezo actuators, in which a thin disk of piezo-active material is arranged on the back of a diaphragm. When a voltage is applied to the piezo, it changes its deflection, moving the diaphragm back and forth between the closed and open position. However, the stroke and pressure strength achievable with such a valve are low.

Another type of switching energy known per se is pneumatic pressure. This can be used to move the shifting member back and forth between the two end positions “open” and “closed”. Pneumatic valves have, among other things, the advantage of being insensitive to electromagnetic fields, and can therefore be used in medical technology, for example, if imaging methods using such fields are to be used. They can be easily constructed and are stable and reliable for a large number of switching cycles. Compared to electrically operated magnetic valves, for example, they have lower energy requirements, and can be both smaller and lighter in construction; also because they do not need to include metals and can therefore be made of plastic. In contrast to piezo valves, they have a much greater shifting travel. There is also virtually no heat generation during operation, which can also be extremely quiet. Depending on the design, particularly easy-to-control throttling is possible due to the proportional mode of operation.

Due to the accelerating trend towards miniaturization, there is also an increasing demand for miniaturized valves. Although the aforementioned piezo-driven valves can be miniaturized well, they exhibit the already mentioned low working stroke and low pressure strength. Particularly in the area of pneumatic switching energy, there is a general lack of miniaturized valves.

### OBJECT OF THE INVENTION AND SOLUTION

Accordingly, the invention is based on the object of providing a device which avoids the disadvantages of the prior art. The working stroke and the pressure strength of the valve should be relatively large. The valve should be realizable in non-metallic materials, and have potential for miniaturization.

The object is solved by a miniaturized hydraulic valve according to claim 1 and its use according to claim 13. Advantageous embodiments can be found in the respective dependent claims, the following description and the figures.

### SUMMARY OF THE INVENTION

What is disclosed is a miniaturized active hydraulic valve, which includes a valve chamber arranged in a housing and having at least one inlet and at least one outlet. A wall of the valve chamber has a shifting member movable in the direction of the inlet and/or the outlet. A fluid-filled drive chamber is arranged on a side of the wall opposite the valve chamber and is connected to a micropump, so that the shifting member can be actively deflected by working fluid which can be pressurized by means of the micropump, so that its position can be changed relative to the inlet (7) and/or outlet.

In some embodiments the shifting member is made of or includes an elastic material or is made of or comprises a rigid material.

In some embodiments the shifting member is selected from the group consisting of an elastic diaphragm, a bellows that at least comprises elastic elements, and a rigid pin.

In some embodiments the micropump includes at least one piezo actuator.

In some embodiments, the micropump is arranged outside the housing of the valve and is fluidically connected thereto.

In some embodiments the micropump is integrated into the housing of the valve.

In some embodiments the micropump includes a reservoir for the working fluid.

In some embodiments, the micropump is arranged to withdraw the working fluid from the environment.

In some embodiments the shifting member is spaced apart from the inlet and/or outlet in a rest position and abuts or plunges into the inlet and/or outlet in an active working position.

In some embodiments the shifting member abuts or plunges into the inlet and/or outlet in a rest position and is spaced apart from the inlet and/or outlet in an active working position.

In some embodiments a shifting member includes an elastic diaphragm clamped at its periphery between two halves of the housing.

In some embodiments the stroke of the shifting member is 1 μm to 300 μm, and/or the closing pressure of the valve is less than or equal to 1.8 bar, and/or the micropump (9) is operable at 1 Hz to 50 kHz.

Also provided is a method of switching a flow of a conveying fluid using a miniaturized active hydraulic valve. For closing the valve, a delivery of a drive fluid takes place in a first pumping direction, such that the pressure in the drive chamber changes, whereby the shifting member moves in a first direction towards the inlet and/or outlet, so as to obtain a first switching state for a conveying fluid, in which the valve is closed and the conveying fluid cannot flow; to open the valve, the drive fluid is delivered in a second, opposite pumping direction, so that the pressure in the drive chamber changes in the opposite direction, whereby the shifting member moves in a second direction away from the inlet and/or outlet, so as to obtain a second switching state in which the valve is open and the conveying fluid can flow. The micropump is used to deliver the drive fluid.

In some embodiments the first switching state is taken when ambient pressure and pressure in the drive chamber are identical, or the second switching state is taken when ambient pressure and pressure in the drive chamber are identical, or the first switching state is achieved with a first increase of the pressure in the drive chamber compared to the ambient pressure, and the second switching state is achieved with an even greater increase thereof, or the first switching state is achieved with a first reduction of the pressure in the drive chamber compared to the ambient pressure, and the second switching state is achieved with an even greater reduction thereof, or the first switching state is achieved with a relative increase of the pressure in the drive chamber compared to the ambient pressure, and the second switching state is achieved with a relative decrease thereof.

In some embodiments the micropump withdraws the working fluid from or delivers it into a reservoir.

### BRIEF DESCRIPTION OF THE DRAWINGS

The invention is explained below by way of example with the aid of figures. Thereby shows the following.

FIG. 1 is a schematic sectional drawing of a miniaturized hydraulic valve according to the invention in the resting state.

FIG. 2 depicts the valve from FIG. 1 in activated state.

FIG. 3 depicts a valve similar to FIG. 1, but with a different valve seat.

FIG. 4 depicts the valve according to FIG. 3 in activated state.

FIG. 5 depicts a valve similar to FIG. 1 with a shifting member in the form of a pin in the open state.

FIG. 6 depicts the valve according to FIG. 5 in closed state.

FIG. 7 depicts a valve with integrated micropump.

### DETAILED DESCRIPTION

The active miniaturized hydraulic valve according to the invention includes a valve chamber arranged in a housing and having at least one inlet and at least one outlet. Fluid flows through the valve chamber when the valve is open, and fluid is present in the valve chamber when the valve is closed but cannot flow because the inlet and/or the outlet are closed.

A wall of the valve chamber has a shifting member movable in the direction of the inlet and/or the outlet. The shifting member is provided to selectively close or open the inlet and/or outlet and thus to provide the valve function.

A fluid-filled drive chamber is arranged on the side of the wall opposite the valve chamber (i.e. on its rear side facing away from the inlet and outlet). It is also designed to be filled with a (working) fluid and in particular a liquid. A liquid is preferred because it is not compressible and is therefore more suitable for energy and power transmission.

The drive chamber is connected to a micropump belonging to the valve and forming at least a functional, optionally also a structural part thereof, in such a way that the shifting member can be deflected by working fluid that can be pressurized by means of the micropump, whereby its position relative to the inlet and/or outlet can be changed. Both a positive and a negative pressure in the drive chamber are feasible for this purpose. Preferably, however, it is an overpressure that leads to a movement of the shifting member in the direction of the inlet and/or outlet. The term “changeable” means, in particular, that the shifting member can be brought close to the inlet and/or outlet to such an extent that the same can be closed by means of the shifting member.

An active microvalve of the type according to the invention has a very small size, since the design according to the invention is kept very simple and can therefore be miniaturized very easily. At the same time, a micropump provides sufficiently high performance, both in terms of flow rate, which enables fast switching changes, and in terms of achievable pressure, which increases the pressure strength of the valve. It can be operated bidirectionally, that is, it can actively support the transition between the two switching states.

Thus, the invention avoids the disadvantages known from the prior art.

The micropump typically performs a large number of pump strokes to provide a single valve stroke. Although a single pump stroke pumps only a small amount of fluid into or out of the drive chamber, at a correspondingly high frequency, which can be, for example, in the range of a few hertz to several tens of thousands of hertz, a sufficient amount of fluid for the valve stroke can be conveyed into or out of the drive chamber in a short time.

Various embodiments of the invention are described in more detail below.

According to one embodiment, the shifting member consists of or comprises an elastic material such as an elastomer. Accordingly, the shifting member is designed to be reversibly expandable so that it warps or bulges out when the pressure in the drive chamber is increased, thus closing the inlet and/or outlet with a valve cover region provided for this purpose. When the pressure is reduced, the elastic shifting member returns to an initial position, which typically results in an open valve.

The advantage of elastic materials lies in their inherent ability to provide a sealing surface towards the inlet and/or outlet.

According to another embodiment, the shifting member is made of or comprises a rigid material such as a metal or a thermoplastic material, for example. This means that an increase in pressure in the drive chamber leads to a displacement of the shifting member, but not to a significant change in its shape. The rigid shifting member includes as well a valve cover region which, in the deflected position, sealingly cooperates with the inlet and/or outlet. It is clear that this region may include optional sealing materials to improve the sealing action between the rigid shifting member and the inlet and/or outlet, which is also substantially rigid.

The advantage of rigid materials lies in their practically unlimited durability, as well as in the more efficient force transmission from the drive chamber to the valve chamber, since with rigid material hardly any energy is lost due to its own deformation.

The shifting member can, for example, be designed as an elastic diaphragm. The diaphragm can be made of silicone or rubber, for example. It can have a round or angular shape. In its edge region, it is firmly connected to the side wall of the valve and/or drive chamber in such a way that it remains connected to the side wall during operation. The advantage of a diaphragm lies in particular in its particularly simple and therefore readily miniaturizable structure.

The shifting member can also be provided as a bellows at least having elastic elements. The elastic elements are then to be arranged at the bending points of the individual layers of the bellows. However, it can also consist entirely of elastic material. In order to achieve a more controllable deformation, the wall thicknesses can be varied in such a way that rather stiff and rather elastic areas result, whereby the latter can preferably be arranged in the bending locations. The advantage of a bellows is that, compared with a diaphragm, it can provide a larger travel distance for the same change in pressure or volume in the drive chamber. This means that fewer strokes of the micropump are required, or it can switch more quickly.

According to a further embodiment, the shifting member is designed as a rigid pin. The pin, which preferably has a circular or square cross-section, is mounted in a matching bore in the wall. If the drive fluid and the conveying fluid are the same, or if an entry of conveying fluid into the drive fluid is unproblematic, special sealing means or particularly low tolerances can be dispensed with. Otherwise, suitable measures familiar to the skilled person must be taken to ensure that mixing of the two fluids during operation is avoided. The advantage of a rigid pin is that it can be made very thin, so that even a slight change in pressure in the drive chamber leads to a large displacement of the pin. The tip of the pin on the valve chamber side can be of plate-like design to provide a larger sealing surface in the direction of the inlet and/or outlet.

The shifting member can be designed to interact sealingly with the inlet and/or outlet on the end face. In this case, it is advantageous if the material pairings of these two surfaces (valve cover region and end face of the inlet/outlet) comprise at least one elastic material. This embodiment is particularly suitable when diaphragms are used, or for shifting members having a large diameter in relation to the inlet/outlet.

The shifting member can also be designed to interact in a sealing manner with the inlet and/or outlet on the shell side. This means that the tip region of the shifting member can be plunged in the bore, the end of which forms the inlet and/or outlet. In this case, a seal can also be achieved without the aforementioned material pairing, provided that the overlap between the tip region and the end of the bore is sufficiently large, i.e. the shifting member is sufficiently plunged into the bore. This embodiment is particularly suitable for pin-shaped, rigid shifting members.

The pin can be cylindrical, so that the tightness improves more and more with increasing plunging depth and can thus be adjusted. The advantage of this design is the high tightness even at low pressure in the working chamber.

It can also be conical or hemispherical, so that tightness is provided only when resting in the wall of the bore. The tightness can then be adjusted via the pressure in the working chamber. The advantage of this design is that a large sealing surface can be achieved with a small working stroke.

According to a preferred embodiment, the micropump has at least one, and preferably at least two, piezo actuators, and is preferably based on the principle of two (or possibly more) passively switching valves, as known, for example, from the publication EP 2222959 A1, which is hereby fully incorporated by reference in the present text. Such micropumps operate robustly and reliably. They allow for bidirectional operation, are economical in energy consumption and are particularly easy to miniaturize. By using a micropump with piezo actuators, the working stroke of a piezo actuator, which is often too small for valves, is instead used to deliver the fluid into the working chamber. In this way, the advantages of pumps comprising piezo actuators can also be used for hydraulic microvalves.

According to one embodiment, the micropump is arranged outside the housing of the valve and is fluidically connected to it in a suitable manner, for example by means of a hose or a channel incorporated in a “fluidic circuit board”. This provides a further advantage, since the structural separation of the unit supplying the operating energy (micropump) and the unit carrying out the valve movement (valve housing) is particularly advantageous in cases where installation space at the point of action is strongly limited.

According to another embodiment, the micropump is integrated into the housing of the valve. This means that the micropump and valve housing form a single unit. A fluid supply duct between micropump and drive chamber is no longer present or is replaced by a duct located within the housing, which is no longer accessible from the outside and is therefore also particularly insensitive. The advantage of such an embodiment is the small size of the entire system, and the possibility of manufacturing the micropump and “passive” components of the valve in a single manufacturing step.

According to one embodiment, the micropump comprises a reservoir for the working fluid. This means that the housing of the micropump comprises a cavity which is preferably pressure balanced (for example by foldable walls). This cavity is connected to an inlet of the micropump, so that by means of the pump working fluid can be delivered towards the drive chamber, and vice versa. Thus, the micropump is independent of the ambient conditions, and full control over the type of working fluid is possible at any time.

According to another embodiment, the micropump arranged to withdraw the working fluid from the environment. Accordingly, a reservoir is not necessary. The inlet of the micropump is connected to the environment and can take working fluid from it and also return it to it.

According to one embodiment, the shifting member is spaced apart from the inlet and/or outlet in a rest position and abuts or plunges into the inlet and/or outlet in an active working position. This embodiment is also referred to as a “normally open” embodiment since the valve is open without energy supply.

According to another embodiment, the shifting member abuts or plunges into the inlet and/or outlet in a rest position and is spaced apart from the inlet and/or outlet in an active working position. This embodiment is also referred to as a “normally closed” embodiment since the valve is closed without energy supply.

According to a further embodiment having a diaphragm as a shifting member, this diaphragm is clamped at its periphery between two halves of the housing. Accordingly, the housing consists of at least two parts which are joined together, with the diaphragm being arranged in the joining plane (or in a plane parallel thereto). On one side of the diaphragm, the valve chamber, the inlet and the outlet are located, and on the other side the drive chamber.

Preferably, the stroke of the shifting member is 1 μm to 300 μm, and/or the closing pressure of the valve is less than or equal to 1.8 bar, and/or the micropump can be operated at 1 Hz to 50 kHz. Tests have shown that with such a stroke, such a closing pressure and such a frequency, a wide range of applications for hydraulic microvalves can be covered.

The invention also relates to a method of switching a flow of a conveying fluid using a miniaturized active hydraulic valve as defined above; to avoid repetition, reference is made to the relevant parts of the description. The method comprises, in addition to providing the valve, the steps of: (i) delivering a drive fluid in a first pumping direction such that the pressure in the drive chamber changes, whereby the shifting member moves in a first direction towards the inlet and/or outlet, so as to obtain a first switching state for a conveying fluid in which the valve is closed and the conveying fluid cannot flow; and (ii) pumping the drive fluid in a pressure in the drive chamber changes in the opposite direction, whereby the shifting member moves in a second direction away from the inlet and/or outlet, so as to obtain a second switching state in which the valve is open and the conveying fluid can flow.

According to the invention, a micropump belonging to the valve is used to deliver the drive fluid.

In other words, by changing the pressure in the drive chamber in one direction, the shifting member is moved towards the inlet/outlet, and by changing the pressure in the other direction, the shifting member is moved away from the inlet/outlet, the pressure change being achieved by means of a micropump according to the invention.

Possible here are both embodiments according to which a rest position is taken when the pressure in the drive chamber corresponds to the ambient pressure, and embodiments according to which the deflected position is taken when the pressure is equal.

According to one embodiment, the first or the second switching state is taken when ambient pressure and pressure in the drive chamber are identical. This means that—depending on the design—a “normally-open” or “normally-closed” valve is provided, which remains in this position without energy supply and moves to the other position when energy is supplied, i.e., active pressure increase or decrease.

Also possible are embodiments according to which a pressure must be actively provided both for taking the rest position and the deflected position; for example, a pressure in the drive chamber increased by a first and a further, even higher value. Similarly, pressures that are lower than the ambient pressure can also be used.

Also possible are embodiments according to which one of the last-mentioned pressures must be greater, and the further mentioned pressure must not be even higher than the first, but lower than the ambient pressure.

It is clear that by varying the respective pressure, the flow rate of the valve can be controllable, so that a variable throttle is provided. Also the tightness may be controllable by means of the pressure, or adapted to the pressure in the inlet and/or outlet, for example. In this respect, the above first and second switching states are to be understood as end points between which the valve according to the invention can certainly also provide desired functionalities that go beyond those of a simple 2-way valve.

According to a further embodiment, the micropump withdraws the working fluid from a reservoir or delivers it into it. The reservoir is preferably integrated into the housing of the micropump. In this way, a self-contained system is provided in which full control over the type of working fluid is possible at all times.

With the above in mind, FIG. 1 shows a schematic, not-to-scale sectional drawing of a miniaturized hydraulic valve according to the invention in the rest position (second switching state). Accordingly, the housing 1 is divided into two parts and has a drive chamber side (top) and a valve chamber side 3 (bottom). The shifting member, which is in the form of a diaphragm 4, is clamped between these sides. The half-space above the diaphragm is the drive chamber 5, the half-space below the diaphragm is the valve chamber 6. The inlet 7 and the outlet 8 lead into the valve chamber 6. The two arrows without reference signs indicate the flow direction of the fluid (not shown);

of course, the reverse flow direction is also possible.

A fluid-conducting duct 10 of the micropump 9, whose two piezo actuators are indicated by the circles, also leads into the drive chamber 5. The electrical connection 11 of micropump 9 is indicated on the left.

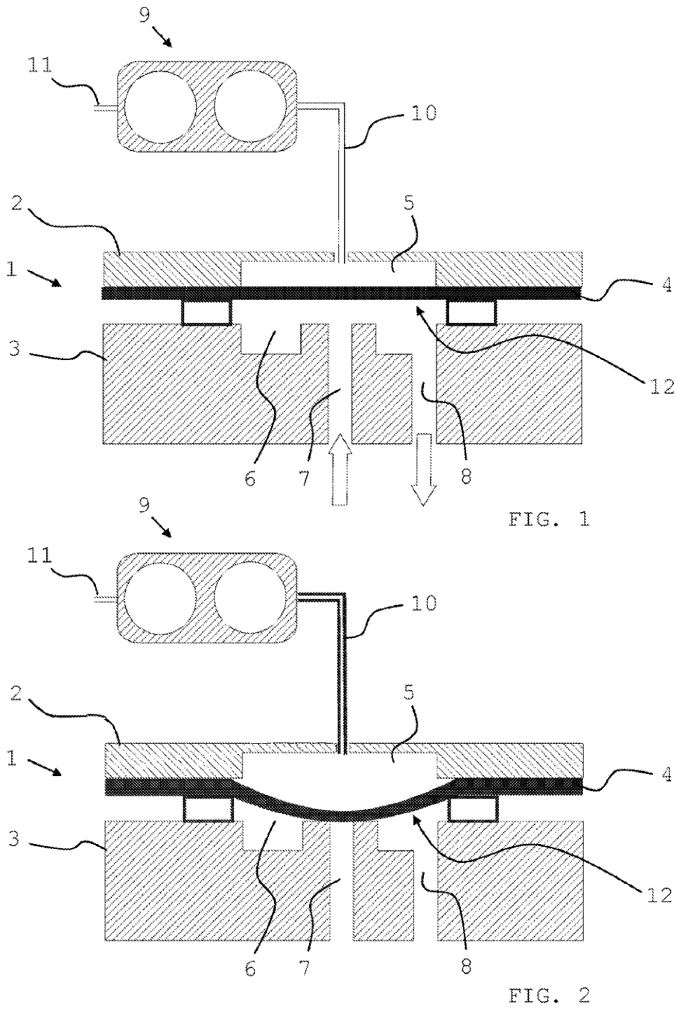

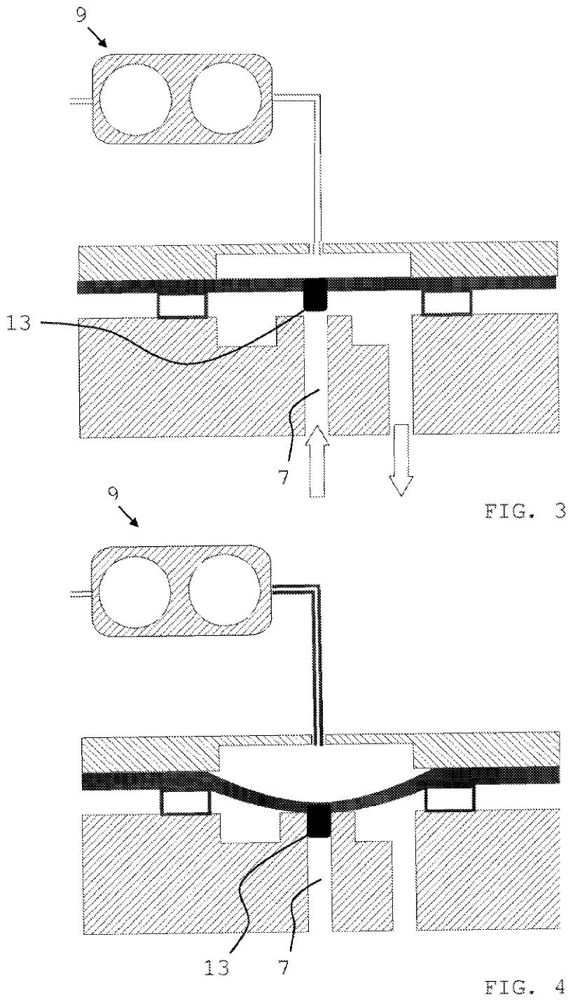

If the micropump 9 is now put into operation, as shown in FIG. 2, it generates an overpressure which is fluidically propagated through the now thicker duct 10 into the drive chamber 5. There it leads to a deformation of the elastic diaphragm in such a way that it deforms in the direction of the valve chamber 6 until it rests with its centrally arranged valve cover region against the inlet 7, closing it fluid-tight: the valve is in the closed working position (first switching state), the fluid can no longer flow. Accordingly, the two arrows at inlet 7 and outlet 8 are missing in FIG. 2.

As can be seen from the two figures, the end portion of the inlet 7 projecting into the valve chamber 6 is projecting. In this way, the stroke of the diaphragm does not have to be as great to close the inlet 7; moreover, the diaphragm can adapt around the end section at a correspondingly high pump pressure (not shown), which further increases the tightness or pressure strength.

FIG. 3 shows a valve similar to FIG. 1, but with a different valve seat. The reference signs are largely omitted for clarity. In contrast to the embodiment shown in FIG. 1, the diaphragm comprises in its central area intended for approaching the inlet 7 an element serving as a sealing member 13, which has a cylindrical shape.

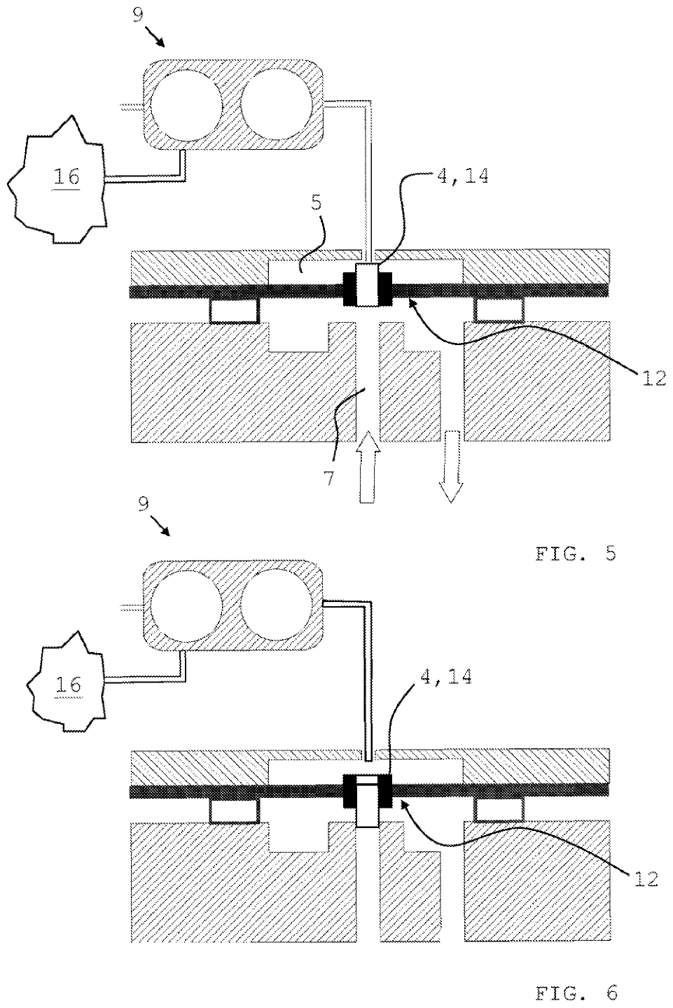

As can be seen from FIG. 4, this sealing member 13 plunges into the inlet 7 when the valve is activated. In doing so, it seals with the inlet 7 not only with the end face of the diaphragm but also, in particular, with the circumferential side of the cylinder, which leads to improved sealing. In addition, if a gap is deliberately left between the lateral surface and the inner wall of the bore of inlet 7, this embodiment can also allow the valve to perform a throttling function, namely if the diaphragm is only partially deflected so that the sealing member 13 is also only partially plunged into inlet 7. A certain, controllable amount of conveying fluid can then flow through the gap.

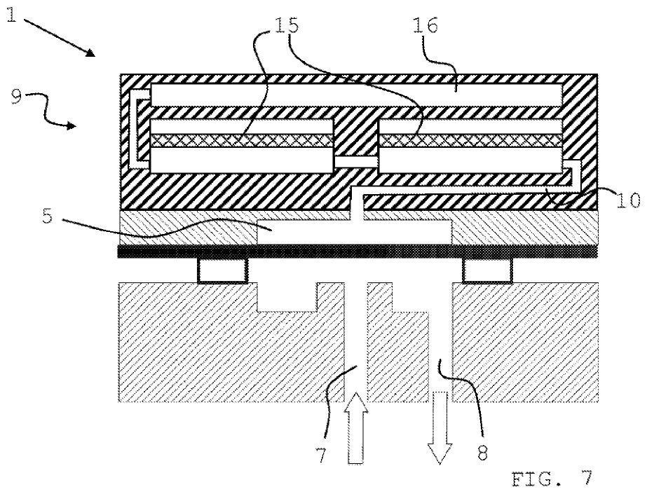

FIGS. 5 and 6 show an embodiment with a shifting member 4 designed as a rigid pin 14. Accordingly, the depicted design does not comprise an elastic diaphragm, but the pin 14, which preferably has a circular or square cross-section, is mounted in a matching guide in the (rigid) wall 12. By increasing the pressure in the drive chamber 5, pin 4 is moved in the direction of the bore of inlet 7 until it closes it in a sealing manner (FIG. 6), so that no more conveying fluid can flow. Pin 4, guide in wall 12 and bore of inlet 7 must be aligned with each other.

Also indicated is a reservoir 16, which is located outside the micropump 9. While it is shown larger in FIG. 5 because it contains more working fluid, it is drawn smaller in FIG. 6.

Finally, FIG. 7 schematically shows an embodiment according to which micropump 9 and valve are integrated into a common housing 1. For reasons of clarity, only some components of the micropump 9 are shown. This comprises two piezo actuators 15, which are connected to each other by means of fluid channels (without reference signs). A fluid-conducting duct 10 (on the right in the figure) of the micropump 9 is connected to the drive chamber 5. Above the two chambers in which the piezo actuators 15 are located, a reservoir 16 is also shown in which working fluid (not shown) can be stored. By means of the micropump 9, this can be conveyed from the reservoir 16 into the drive chamber 5. The resulting increase in volume and pressure in the drive chamber 5 can then move the shifting member 4, which is shown here in the open position, in the direction of the inlet and outlet 7, 8, as shown in FIG. 2 and FIG. 4.

According to an embodiment not shown, the reservoir 16 is arranged outside the integrated micropump 9.

According to another embodiment, the micropump takes the working fluid from the environment; a reservoir is then not necessary. Such an embodiment is indicated in FIGS. 1 to 4. FIGS. 5 and 6 show an embodiment with reservoir 16 arranged outside the micropump.

### LIST OF REFERENCE SIGNS

1 housing
2 drive chamber side
3 valve chamber side
4 shifting member
5 drive chamber
6 valve chamber
7 inlet
8 outlet
9 micropump
10 duct
11 connection
12 wall
13 sealing member
14 pin
15 piezo actuator
16 reservoir

1. A miniaturized active hydraulic valve, comprising a valve chamber (6) arranged in a housing (1) and having at least one inlet (7) and at least one outlet (8) that is different from the inlet (7), wherein a wall (12) of the valve chamber (6) comprises an shifting member (4) movable in the direction of the inlet (7) and/or the outlet (8), and wherein a fluid-filled drive chamber (5) is arranged on a side of the wall (12) opposite the valve chamber (6), wherein the drive chamber (5) is connected only single sided by means of a fluid-carrying duct (10) to a micropump (9) by means of which an amount of working fluid being sufficient for the valve stroke can be conveyed into this drive chamber (5) and outward in an opposite direction, so that the shifting member (4) can be actively deflected by working fluid which can be pressurized by means of the micropump (9), so that its position can be changed relative to the inlet (7) and/or outlet (8) such that it can be closed by means of the shifting member (4).

2. The valve according to claim 1, wherein the shifting member (4) is made of or comprises an elastic material, or is made of or comprises a rigid material.

3. The valve according to claim 1, wherein the shifting member (4) is selected from the group consisting of an elastic diaphragm, a bellows that at least comprises elastic elements, and a rigid pin (14).

4. The valve according to claim 1, wherein the micropump (9) comprises at least one piezo actuator.

5. The valve according to claim 1, wherein the micropump (9) is arranged outside the housing (1) of the valve and is fluidically connected thereto.

6. The valve according to claim 1, wherein the micropump (9) is integrated into the housing (1) of the valve.

7. The valve according to claim 1, wherein the micropump (9) comprises a reservoir (16) for the working fluid.

8. The valve according to claim 1, wherein the micropump (9) is arranged to withdraw the working fluid from the environment.

9. The valve according to claim 1, wherein the shifting member (4) is spaced apart from the inlet (7) and/or outlet (8) in a rest position, and abuts or plunges into the inlet (7) and/or outlet (8) in an active working position.

10. The valve according to claim 1, wherein the shifting member (4) abuts or plunges into the inlet (7) and/or outlet (8) in a rest position, and is spaced apart from the inlet (7) and/or outlet (8) in an active working position.

11. The valve according to claim 1, wherein the same comprises, as a shifting member (4), an elastic diaphragm clamped at its periphery between two halves of the housing (1).

12. The valve according to claim 1, wherein the stroke of the shifting member (4) is 1 μm to 300 μm, and/or the closing pressure of the valve is less than or equal to 1.8 bar, and/or the micropump (9) is operable at 1 Hz to 50 kHz.

13. A method of switching a flow of a conveying fluid using a miniaturized active hydraulic valve according to any one of the preceding claims, wherein
for closing the valve, a delivery of a drive fluid takes place in a first pumping direction, such that the pressure in the drive chamber (5) changes, whereby the shifting member (4) moves in a first direction towards the inlet and/or outlet (7; 8), so as to obtain a first switching state for a conveying fluid, in which the valve is closed and the conveying fluid cannot flow; and
to open the valve, the drive fluid is delivered in a second, opposite pumping direction, so that the pressure in the drive chamber (5) changes in the opposite direction, whereby the shifting member (4) moves in a second direction away from the inlet and/or outlet (7; 8), so as to obtain a second switching state in which the valve is open and the conveying fluid can flow;
wherein a micropump (9) is used to deliver the drive fluid.

14. The method according to claim 13, wherein
the first switching state is taken when ambient pressure and pressure in the drive chamber (5) are identical, or
the second switching state is taken when ambient pressure and pressure in the drive chamber (5) are identical, or
the first switching state is achieved with a first increase of the pressure in the drive chamber (5) compared to the ambient pressure, and the second switching state is achieved with an even greater increase thereof, or
the first switching state is achieved with a first reduction of the pressure in the drive chamber (5) compared to the ambient pressure, and the second switching state is achieved with an even greater reduction thereof, or
the first switching state is achieved with a relative increase of the pressure in the drive chamber (5) compared to the ambient pressure, and the second switching state is achieved with a relative decrease thereof.

15. The method according to claim 13, wherein the micropump (9) withdraws the working fluid from or delivers it into a reservoir (16).
